(19) United States
(12) Patent Application Publication
(10) Pub. No.: US 2004/0027377 A1
(43) Pub. Date: Feb. 12, 2004

(54) User interface design and validation including dynamic data

(76) Inventors: Grace Hays, San Jose, CA (US); Jingjun Shu, San Jose, CA (US); Shashank Varshney, Sunnyvale, CA (US); Xiangqian He, Sunnyvale, CA (US); Florence Perot, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/212,827

(22) Filed: Aug. 6, 2002

(51) Int. Cl. G09G 5/00

(52) U.S. Cl. 345/760; 345/762

(57) ABSTRACT

A method for designing a user interface may include the steps of selecting multiple target devices, selecting dynamic data sources, converting dynamic data to static data, designing a user interface including the converted static data, validating the user interface on selected target devices in a device simulator, and deploying the user interface to the selected target devices.

### RELATED APPLICATIONS

The present application is related to commonly assigned U.S. patent application Ser. No. [Attorney Docket No. 100200590-1] entitled “CREATION OF USER INTERFACES FOR MULTIPLE DEVICES,” and U.S. patent application Ser. No. [Attorney Docket No. 100200591-1] entitled “SYSTEM FOR AND METHOD OF DEVELOPING A COMMON USER INTERFACE FOR MOBILE APPLICATIONS,” filed concurrently herewith, the disclosures of which are hereby incorporated by reference in their entireties.

### FIELD OF THE INVENTION

The present invention relates to software for designing user interfaces for devices, and more specifically to creating user interfaces for multiple devices.

### BACKGROUND OF THE INVENTION

A User Interface (UI) facilitates data exchange between a user and electronic equipment by formatting output data and accepting input data in a manner convenient for the user. A well-designed UI improves user efficiency and enhances a user's ability to completely utilize the capabilities of the particular machine being employed.

Many UIs process a combination of static and dynamic information. Static information remains constant after deployment to a target device, and may be relatively easy for user interface designers to implement, as the formatting of static data may be validated before deployment. Static data includes, for example, menu labels, structure definitions, and other non-changing data and information. Dynamic data, however, may be changeable data that will be collected and displayed to the user after UI deployment. In many user interface design situations, application software may designate a retrieval location, or path, from which to obtain dynamic data information. Although the location of the dynamic data may be easily specified, the exact content of the dynamic data will not be known until the application may be actually run on the target device. The difficulty in ascertaining the dynamic data content of a UI may result in problems in testing and deploying the UI.

For user interfaces intended for multiple devices, the inability to test dynamic information before deployment of a UI may be extremely problematic for UI developers. Problems may arise in testing dynamic information because of the potential variety of display and input devices. For example, a small device with a four-line display may not be capable of displaying as much user-readable information as a device with a large forty-line display, so the format of dynamic data displayed on the two devices will be different. UI development on mobile devices may be particularly challenging for designers because of the limited processing and display capabilities of those devices compared to stationary and desktop devices. Additionally, a UI designer must design and test a UI on each target device. This process may be particularly inefficient if the UI will be used on many devices, as the UI must be re-deployed and re-tested if any changes must be made to the UI.

### SUMMARY OF THE INVENTION

The present invention may be directed to a method for designing a user interface including the steps of selecting multiple target devices, selecting dynamic data sources, converting dynamic data to static data, designing a user interface including the converted static data, validating the user interface on selected target devices in a device simulator, and deploying the user interface to selected target devices.

### BRIEF DESCRIPTION OF THE DRAWINGS

FIG. 1 is a block diagram of an apparatus for designing multiple user interfaces according to an embodiment of the present invention;

FIG. 2 is a flow diagram of the steps included in a method of designing, validating, and generating a UI according to an embodiment of the present invention;

FIGS. 3A and 3B are flow diagrams of a method of generating a UI implemented display as a computer program product according to an embodiment of the present invention;

FIG. 4 is a flow diagram of a method of generating a UI implemented display according to one embodiment of the invention; and

FIG. 5 is a screen shot of a display illustrating one embodiment of the present invention.

### DETAILED DESCRIPTION

A User Interface (UI) may be, typically, a graphical approach to electronic equipment control, that allows for simplified use of the electronic equipment. Given standard data input and output devices, UI designers may design and test a UI. However, with the rising popularity of electronic equipment, UI designers are no longer designing to a relatively homogenous collection of devices, and UIs are often customized to match the capabilities of the UI target devices.

Most UIs contain both static and dynamic data types, so development of UI designs, by necessity, often includes both static and dynamic data design elements. Static data displayed in a UI is not changed after deployment and may be designed and tested before deployment of the UI. However, dynamic data used by a UI after deployment may be difficult to anticipate and test, making complete validation of UIs difficult to complete without deployment of the UI to the target device. A solution is needed that will enable efficient development of UIs with dynamic data content by allowing the formatting and validation of dynamic data before deployment of a UI.

FIG. 1 is a block diagram of an apparatus for designing multiple user interfaces according to one embodiment of the present invention. The apparatus may include central processing unit (CPU) 101, memory 102, display device 103, and secondary storage device 104. Note that the number and variety of components may vary. In a preferred embodiment, memory 102 may include stored therein software 105 and support file 106.

Software 105 may include target device selection module 108, dynamic data selection module 109, user interface design module 110, target device simulator module 111, and deployment module 112. Also included in a preferred embodiment may be user interface 107 (this user interface operable to control development, testing and validation routines supported by software 105 and executed by UI development apparatus 113), displayed on display device 103. UI development apparatus 113 may be connected to target devices 114 and/or 115. CPU 101 may also be connected to computer network 116 in some embodiments. Note that FIG. 1 illustrates only one embodiment of the present invention and that in other embodiments, the components and modules, as well as the numbers of components and modules included, may vary.

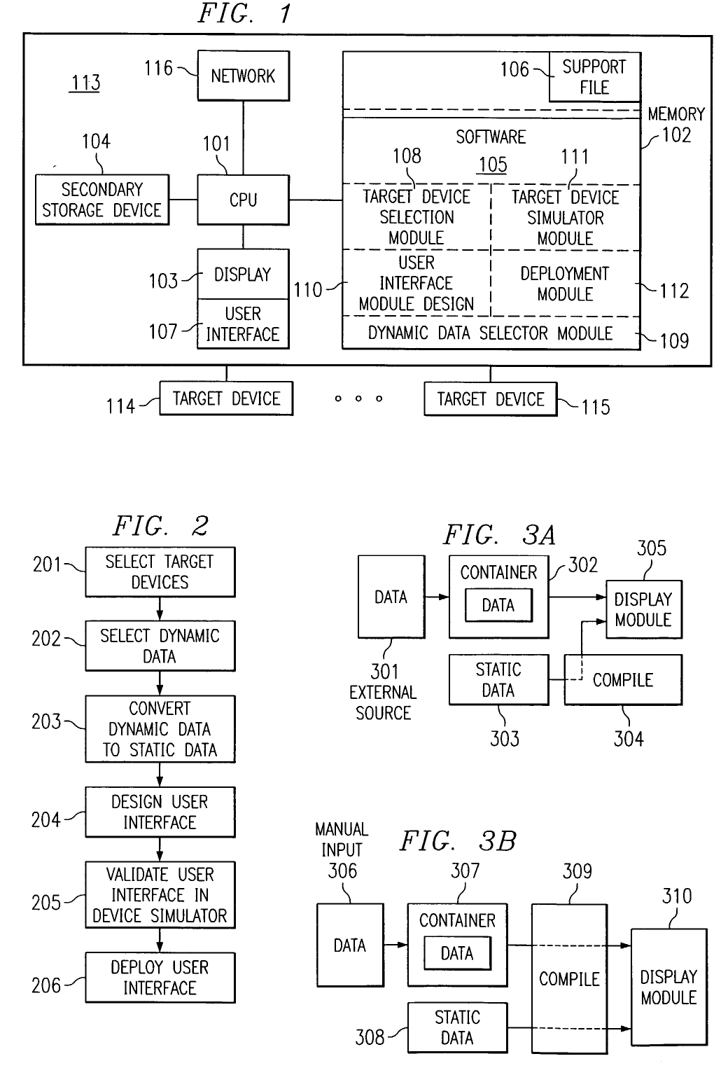

FIG. 2 is a flow diagram of the steps included in a method of designing, validating, and generating a UI according to an embodiment of the present invention. A preferred embodiment of the method uses programmed steps implemented using computer hardware and software of FIG. 1. In step 201, target devices on which a UI will be deployed may be selected. Selection of devices may be effected in many ways; however, in a preferred embodiment, selection may take place using a computer program module implemented using general purpose computer hardware (such as a PC or high-end workstation) and software as in FIG. 1. A preferred embodiment may contemplate a drop-down list selection for device simulators or specific devices, but other methods such as drag-and-drop, point-and-click, direct keyboard entry, voice selection, direct input of selected devices or device simulators from a file, or touch-screen selection are also contemplated to select device simulators or specific devices. A drop-down list selection method contemplated by a preferred embodiment allows a user to select device simulators from a menu list which were previously registered by the user to the preferred embodiment via a separate dialog interface.

In step 202, a dynamic data source, also known as a content source, may be selected to be included in a user interface. Dynamic data source selection may utilize multiple, alternative selection methods, such as drag-and-drop, point-and-click, direct keyboard entry, voice selection, direct input from a file or touch-screen selection. A preferred embodiment may use a drag-and-drop dynamic data source selection method. Dynamic data source selection may be performed by selecting a file contained on secondary storage device 104 or network 116. Dynamic data may be changeable data, and data contained by a dynamic data source during testing may differ from data contained by a dynamic data source after UI deployment. A dynamic data source should, however, contain data similar to the data anticipated in the source after deployment, thereby providing data suitable for testing the user interface.

A dynamic data file may contain sample data including data selected to fully exercise and validate a full range of device UI capabilities. For example, dynamic data may include examples of all valid displayable characters, symbols, icons, etc., over a broad range of displayable font types and sizes, string lengths, etc. In a preferred embodiment, a dynamic data source file may be an Extensible Markup Language (XML) file. A dynamic data file may be selected by directly specifying the file location using a keyboard or other means of input, but a drag-and-drop method may be contemplated by a preferred embodiment, where a dynamic data file may be selected from a list of files displayed. In a preferred embodiment, a dynamic data file location may be specified using an XPath specification generated automatically or entered manually. A dynamic data file may also be selected from a file list using a selection method, such as drop-down list, point-and-click, or by specifying a Universal Resource Locator (URL) location for dynamic data that may be located on a network.

In step 203, dynamic data selected in step 202 may be converted to static data. The conversion may be accomplished by specifying a format in which to display dynamic data. In a preferred embodiment, dynamic data formatting may be accomplished by specifying a container in which to put dynamic data. For example, if a list container is specified in step 203, then dynamic data will be loaded from a dynamic data source selected in step 202 and displayed as static data in a list container format on display device 103. In a preferred embodiment, the location of dynamic data may be specified by XPath, and this XPath location specification may be used to automatically display selected dynamic data as static data. Many container types may be available for the static display of dynamic data, including, but not limited to, lists, radio buttons, checkboxes, choiceboxes, menu items, and columns within a table. Dynamic data in XML format may be contemplated by a preferred embodiment for conversion to static data. This preferred embodiment also contemplates that XML dynamic data will be converted to static Wireless Markup Language (WML), Compact Hypertext Markup Language (CHTML), Extensible Hypertext Markup Language (XHTML) or Pocket HTML elements in step 203.

In step 204, a user interface may be designed that includes static data converted from dynamic data in step 203. In a preferred embodiment, a desired UI layout appearance may be designed using a computer program module that provides for the selection of elements from a palette or other selectable arrangement or list of elements. Selectable elements may include, but are not limited to, action elements, input elements, display elements, and specific elements. Static data resulting from dynamic data conversion in step 203 may also be selectable for incorporation in a UI design. The computer program module enables placement of selectable elements and data such that the desired UI layout may be designed. Once a desired UI layout is achieved, the method may generate code allowing selected target devices to duplicate the appearance of a UI. Code generation may occur after each selectable element is incorporated in the UI, or after all selectable elements have been placed in the UI. In a preferred embodiment, code generation may occur after each selectable element is placed in the UI. The resultant code generated may be a mark-up language such as WML, Hypertext Markup Language (HTML), CHTML XHTML or Pocket HTML. Note that in alternative embodiments, a UI design may be generated directly using a language such as WML, XHTML, CHTML, Pocket HTML, or other markup language, or by using methods not employing a selectable element module.

In step 205, a UI design may be validated on the deployment devices selected in step 201. In one embodiment, a UI design is validated if the deployment device on which the UI will be deployed is able to duplicate the desired appearance of a UI, given appropriate instructions. A method embodied in FIG. 2 contemplates that a UI may be validated using target device simulator module 111 as shown in FIG. 1. Step 205 in a preferred embodiment may occur after the addition of each user interface element to a user interface, or after all elements have been added to a user interface design.

In step 206, a UI design may be deployed to a target device or devices selected in step 201. Deployment of a UI may involve the generation of specific control language that will enable a selected target device or environment to render the desired appearance of UI content. In a preferred embodiment, UI content information may be specified in a WML file and content display information may be controlled by a second file type often called an Extensible Stylesheet Language (XSL) stylesheet. A preferred embodiment contemplates the generation or use of XSL stylesheets by deployment module 112. An XSL stylesheet may be a file that describes to a selected target device or environment how to display a UI, while UI information may be typically specified in an WML file. An XSL stylesheet may be used to map, or translate, UI content specified in an WML file. However, the invention also contemplates other methods of controlling UI content, such as by XML, CHTML or HTML-based languages, and other methods for controlling the display of a UI, such as by WAP or iMode protocols. A preferred embodiment may also allow a user to select a deployment location for dynamic data XML files, if a deployment location of a dynamic data source will be different from a location specified during validation of a user interface.

FIGS. 3A and 3B are detailed flow diagrams of alternative embodiments of the present invention. FIG. 3A is an embodiment that uses an external data source. In step 301, an external data source may be selected. Data from a data source may be then formatted into a container in step 302. Static data may also be selected to be included in a UI in step 303. Both external data from the selected external data source in step 301 and static data selected in step 303 may be compiled into code in step 304. Any resulting code may be displayed by a display module in step 305. A method illustrated in FIG. 3B may accept manual input of data in step 306. Manual input data may be formatted into a container in step 307. Static data may also be selected to be included in a UI in step 308. Both static data selected in step 308 and manual input data selected in step 306 may be compiled into code in step 309. Any code compiled in step 309 may be displayed in step 310.

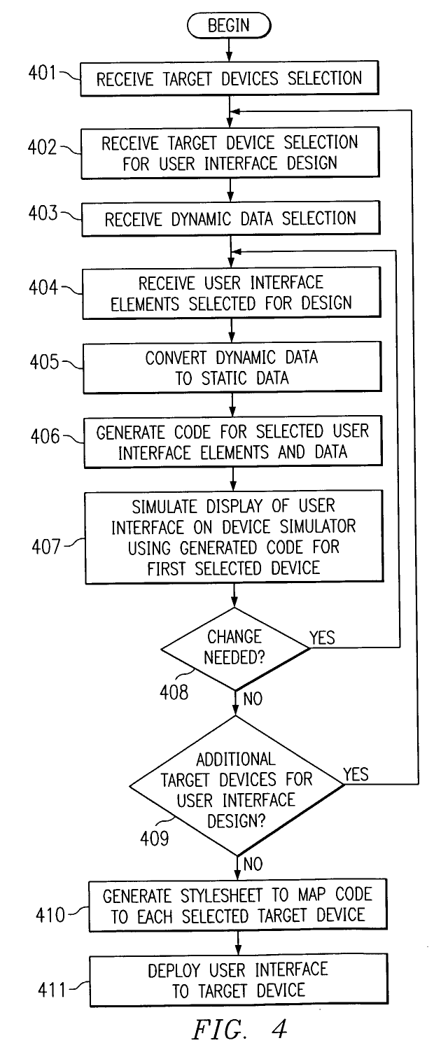

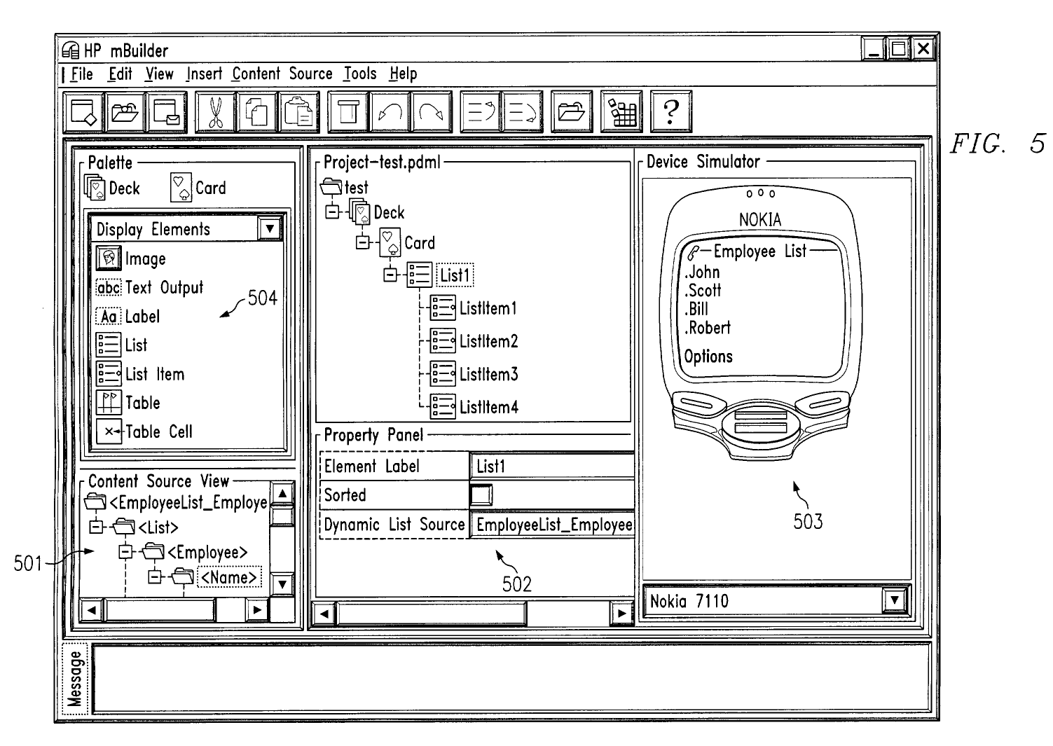

FIG. 4 is a flow diagram of a method of generating a UI implemented display by a computer program product in accordance with a preferred embodiment of the invention. In step 401, a program may receive user selection of target devices or target device simulators. A drop-down list selection method, as described in connection with FIG. 1, may be provided. In step 402, a program may receive user selection of a target devices or target device simulators for user interface design. In a preferred embodiment, the target devices or target device simulators for user interface design are selected from the target devices or target device simulators selected in step 401. In step 403, a program may receive user selection of dynamic data sources. In a preferred embodiment a user may specify a dynamic data file location directly, or a computer program product may provide a selectable list of files. Although many file types are contemplated as providing suitable sources of dynamic data, such as rich text format files, plain text files, and/or word processor format files, in a preferred embodiment, dynamic data sources may be formatted as XML files. Once a dynamic data source is selected, a computer program product may display the current contents of a dynamic data source to a user. In a preferred embodiment, dynamic data file content information may be displayed in a portion of a computer program product user interface as shown in FIG. 5.

In step 404, a computer program may receive UI elements selected by a user for incorporation in a UI design. Step 404 may use a drag-and-drop selection method for UI elements in a preferred embodiment of the invention, but other methods such as drop-down list or point-and-click may be used. Step 404 may enable selection of UI elements including, but not limited to, such elements as action elements, input elements, display elements, and/or specific elements.

In step 405, dynamic data selected in step 403 may be converted into static data. Dynamic data may be assigned a format, also known as a container, for eventual display in a deployed UI. Many different containers may be available for dynamic data display as static data. For example, dynamic data may be displayed as static data in formats such as lists, radio buttons, checkboxes, choiceboxes, menu items, and columns within a table in a preferred embodiment.

In step 406, a program may generate code for each selected UI element, including static elements generated from dynamic data conversion in step 405. Code generation may take place after all elements and data sources comprising a UI are selected in step 404, or may take place as each individual element or data source is selected. In a preferred embodiment, code may be generated in step 406 as each UI element is selected by a user in step 404. Similarly, code may also be immediately generated in step 406 following a dynamic data to static data conversion in step 405. Code generated by a program may use a variety of languages, but uses a CHTML, XHTML, Pocket HTML and WML mark-up languages in a preferred embodiment.

In step 407, generated code may be used by a program to simulate the display of a UI by a target device selected in step 402. A preferred embodiment may have a device simulator module, such as a module illustrated in FIGS. 1 and 5. Each UI display may be validated by the user to determine if a UI being simulated by a device simulator reflects a desired UI design. The simulator module may be an embedded simulator, an integrated simulator or an external simulator. If changes to a UI are required by a user, a program may enable a user to change UI elements to correctly display a UI on each device using tools available in steps 404 and 405. Any changes may be made globally, so all selected devices may be affected, or changes may be made to individual selected target devices.

In step 408, a test may be performed to determine whether additional changes are needed to a UI. If additional changes are needed, the program may routine may branch to step 404 to enable a user to change the UI. If no changes are needed, the routine may continue on to step 409. In step 409, a test may be performed to determine whether there are additional target devices for UI design. If so, the routine may branch to step 402, enabling the selection of additional target devices for UI design. If there are no additional target devices for UI design, the program routine may continue on to step 410.

In step 410, a program according to a preferred embodiment may generate stylesheets for each device selected in step 401. Generated stylesheets may contain information that allow proper display of a UI on a target device. In a preferred embodiment, generated stylesheets may use the XSL language to control mapping of mark-up language code generated in step 406. Finally, in step 411, a UI may be deployed to a target device by a program.

FIG. 5 is a screen shot of a display generated by a UI development tool according to an embodiment of the invention. A display may comprise dynamic data source view window 501, dynamic data source property window 502, and/or device simulator module 503. A display may further comprise UI design component 504. Dynamic data source view window 501 may be configured to display the contents of a dynamic data source selected by a user in step 202 illustrated in FIG. 2. Dynamic data source view window 501 in a preferred embodiment may display both the content of a dynamic data source selected by the user, and a container in which data contained in a dynamic data source may have been placed. For example, dynamic data source view window 501 illustrated in FIG. 5 shows four employee names, John, Scott, Bill, and Robert, that have been retrieved from a dynamic data source specified by the user. The employee names have been placed in a list container, and such placement results in the names being displayed in a list format when deployed in a UI.

Dynamic data source property window 502 may show the location of a dynamic data source selected by a user. A dynamic data source may be located on secondary storage device 104 or in memory 102 as shown in FIG. 1. A dynamic data source may also be located on a network or other remote location connected to CPU 101 shown in FIG. 1. Returning to FIG. 5, the content of a dynamic data source selected by a user may be displayed in device simulator module 503, with formatting according to a container in which the dynamic data was placed. FIG. 5 also shows UI design window 504 that may contain selectable static elements available for user selection during UI design. In the example UI design window 504 shown in FIG. 5, list and table display elements are shown.

What is claimed is:

1. A method for designing a user interface comprising:
selecting multiple target devices;
selecting dynamic data sources;
converting dynamic data to static data;
designing a user interface including said static data; and
validating said user interface on said selected target devices in device simulator.

2. The method of claim 1 further comprising:
deploying said user interface to said selected target devices.

3. The method of claim 1 further comprising:
accessing XML files and selecting dynamic data sources from said XML files.

4. The method of claim 1 wherein said step of selecting dynamic data sources uses a drag-and-drop selection method to select said dynamic data sources.

5. The method of claim 1 wherein said step of converting includes converting XML dynamic data to said static data.

6. The method of claim 5 wherein said dynamic data conversion step converts dynamic data to static mark-up language elements selected from an XML content source to generate a user interface.

7. The method of claim 1 wherein said dynamic data sources selection is from files containing sample data.

8. The method of claim 1 wherein said step of designing a user interface includes the step of selecting user interface elements from a selectable list of such elements.

9. The method of claim 1 wherein said converting step occurs before said validation step.

10. The method of claim 1 wherein said validation step occurs after the addition of each user interface element to the user interface.

11. An apparatus comprised of a computing device having at least one central processing unit and a memory coupled to a central processing unit, said computing device enabling the design of a user interface when said computing device employs a computer application that comprises:
a user interface comprising:
a target device selection module;
a dynamic data selection module;
a user interface design module; and
a target device simulator module.

12. The apparatus of claim 11 further comprising:
a deployment module.

13. The apparatus of claim 11 further comprising a dynamic to static data conversion module.

14. The apparatus of claim 13 wherein said dynamic data conversion module converts XML dynamic data to WML, CHTML, XHTML or Pocket HTML static data elements.

15. The apparatus of claim 11 wherein said dynamic data selection module selects from files containing XML sample data.

16. The apparatus of claim 11 wherein said simulator module is an embedded simulator, an integrated simulator or an external simulator.

17. A computer program product comprising computer-readable code stored on computer-readable medium, said computer program comprising:
computer readable program code for receiving a target device selection;
computer readable program code for receiving a dynamic data selection;
computer readable program code for receiving a user interface element selection;
computer readable program code for generating code from selected user interface elements and selected dynamic data;
computer readable program code for simulating display of generated code on selected target devices; and
computer readable program code for generating stylesheets.

18. The computer program product of claim 17 comprising:
computer readable program code for deploying user interface to selected target devices.

19. The computer program product of claim 17 wherein said user interface element selection computer readable program code and said code generation computer readable program code further comprise:
a computer readable program code for tracking changes to said user interface.

20. The computer program product of claim 19 wherein said computer readable program code for tracking changes is used by said computer readable program code for generating stylesheets.

21. The computer program product of claim 17 wherein said computer readable program code for receiving dynamic data selection further comprises:
computer readable program code for displaying dynamic data content.

22. A computer system having at least one processing unit, at least one memory unit, and at least one display unit, said computer system further comprising:
means for selecting target devices;
means for converting dynamic data to static data;
means for designing a user interface including said static data; and
means for validating said user interface, enabling a user to simulate display of said user interface on selected target device.

23. The computer system of claim 22 wherein said means for converting dynamic data to static data generates user interface elements from XML files.

24. The computer system of claim 22 wherein said user interface elements comprise lists, radio buttons, checkboxes, choiceboxes, menu items, and columns within a table.
